(19) United States
(12) Patent Application Publication
(10) Pub. No.: US 2005/0102508 A1
(43) Pub. Date: May 12, 2005

(54) Method, computer readable storage, and system to provide security printing using a printer driver

(76) Inventor: So-hye Kim, Suwon-si (KR)

Correspondence Address: STANZIONE & KIM, LLP, 1740 N STREET, N.W., FIRST FLOOR, WASHINGTON, DC, 20036, US

(21) Appl. No.: 10/975,451

(22) Filed: Oct. 29, 2004

(30) Foreign Application Priority Data
Nov. 10, 2003 (KR) 2003-79164

(51) Int. Cl. H04L 9/00

(52) U.S. Cl. 713/165

(57) ABSTRACT

A method, computer readable storage, and system that provides security printing using a network printer. More particularly, a method, computer readable storage. and system that provides security printing using a general purpose printer that does not support an encryption function. The system can include at least one terminal having a printer driver and a network printer connected to the terminal via a network. Output data can be encoded at a first terminal and the encoded output data can be stored in a predetermined location designated by a user. The encoded output data that is stored in the predetermined location is decoded at a second terminal, the decoded output data is transferred to the network printer, and the decoded output data is printed.

### CROSS-REFERENCE TO RELATED APPLICATIONS

This application claims the priority of Korean Patent Application No. 2003-79164, filed on Nov. 10, 2003, in the Korean Intellectual Property Office, the disclosure of which is incorporated herein in its entirety by reference.

### BACKGROUND OF THE INVENTION

1. Field of the Invention

The present general inventive concept relates to a method, computer readable storage, and system to provide security printing using a network printer, and more particularly, to a method, computer readable storage, and system providing security printing using a general purpose printer.

2. Description of the Related Art

With the increasing importance of information security, various methods for securing information have been proposed. Access to information can be restricted according to the degree of importance of information. Although the restriction of access to information is generally performed on files in computers, it may be also applied to files to be output to printers. Conventional methods for security printing in printer-related fields make it possible to perform security output for specific users in such a way that printer drivers encrypt output data and network printers decrypt the encrypted output data before output.

FIG. 1 is a flowchart illustrating a conventional method for security printing in a printer that supports encryption. Referring to FIG. 1, a user works in various application programs of a terminal connected to a network and selects a print command if the user desires to output the worked document. In step S101, the terminal connected to the network checks if a print command is selected. If the user selects the print command and security output in step S102, a print driver of the terminal connected to the network displays a message that requests the user to input a password, in step S103.

In step S104, the user inputs the password and executes the print command. In step S105, the printer driver encodes output data created in the application programs and the password input by the user and transmits the encoded output data to the network printer. The transmitted output data is stored in a memory within the network printer.

If the user desires to output the document, the user selects the document stored in the memory and the network printer requests the user to input the password accordingly. If the user inputs the password in step S106, the network printer checks if a security function is set in the received output data in step S107. In other words, the network printer checks if the password is included in a header of the output data. If the security function is set, the password is extracted from the output data in step S108.

In step S109, the password included in the output data received from the terminal is compared with the password input by the user to determine whether the two passwords are identical.

If the two passwords are identical, the data received from the terminal is printed using a printer engine in step S110. If the two passwords are not identical, the user is requested to input a password again in step S1 or the data transmitted from the terminal is deleted to terminate security output.

If the user does not select security output in step S102, the output data is directly printed in step S110 by user's execution of the print command of step S112.

However, to support such a password authentication function, a printer driver and a network printer that can support the security function are needed in pairs.

Also, security output is realized when a document is output to a network printer that supports encryption. However, when the document is output to a general network printer, since encryption is not supported, security output is not achieved and the document is directly output.

### SUMMARY OF THE INVENTION

Accordingly, it is an aspect of the present general inventive concept to provide a method, computer readable storage, and system providing security printing to perform security output to a low-price, general purpose printer that does not support encryption by performing password decryption in a printer driver.

It is an additional aspect of the present general inventive concept to provide a method, computer readable storage, and system providing security printing, which makes it possible to more flexibly implement a security operation by implementing the security operation using software instead of hardware.

Additional aspects and advantages of the present general inventive concept will be set forth in part in the description which follows and, in part, will be obvious from the description, or may be learned by practice of the general inventive concept.

The present general inventive concept also provides a method and system providing security printing, which makes it possible to tighten security of output data by disabling output of output data until a password is decrypted using a password input by a user.

The foregoing and/or other aspects and advantages of the present general inventive concept are achieved by providing a method of providing security printing on a network printer that includes at least one terminal having a printer driver and a network printer connected to the terminal via a network. The method includes the operations of encoding output data at a first terminal and storing the encoded output data in a predetermined location designated by a user; and decoding the encoded output data that is stored in the predetermined location at a second terminal, transferring the decoded output data to the network printer, and printing the decoded output data.

The encoding operation may include receiving a password from the user or other external source; encoding the password and the output data to create the encoded output data; and storing the encoded output data in the predetermined location.

The encoding operation may further include storing an encoding additional information file in the predetermined location, the encoding additional information file may include at least a user name, a document name, a file size, and time of encoding.

The encoding additional information file may have the same file name as that of the encoded output data, but have an extension different from that of the encoded output data. The predetermined location may be a terminal connected to the network.

The decoding operation may include receiving a password and a decoding/print command from the user at the first terminal; extracting a password included in the encoded output data at the second terminal according to the decoding/print command; comparing the extracted password with the password input by the user; and deleting the extracted password, decoding the output data, and transferring the decoded output data to the network printer, if the two passwords are identical.

The decoding operation may further include displaying a decoding additional information file, and the decoding additional information file may read and display the encoding additional information file. The decoding operation may further include displaying a result of decoding and a printing state.

The foregoing and/or other aspects of the present general inventive concept can also be achieved by providing at least two terminals having printer drivers and a network printer connected to the terminals via a network. The terminals can include a first terminal, which receives a password from a user, encodes the password and output data, and stores the encoded output data in a predetermined location; and a second terminal, which can decode the encoded output data that is stored in the predetermined location and outputs the decoded output data to the network printer.

The first terminal may include the printer driver. The printer driver may include an encoding unit, which receives the password from the user and stores in the predetermined location the encoded output data obtained by encoding the password and output data; and a user interface unit, which receives the password or a control command from the user or displays a security work state and acts as an interface between the user and the first terminal.

The second terminal may include the printer driver, and the printer driver may decode the encoded output data which is stored in the predetermined location and output the decoded output data to the network printer. The predetermined location may be a terminal connected to the network.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a flowchart illustrating a conventional method for security printing in a printer that supports encryption;

FIG. 2 is a block diagram of a system for security output including a general purpose printer that does not support encryption, according to an embodiment of the present general inventive concept;

FIG. 3 is a block diagram of a terminal, according to an embodiment of the present general inventive concept;

FIG. 4 is a block diagram of a terminal to implement a decoding operation, according to an embodiment of the present general inventive concept;

FIG. 5 is a block diagram of a network printer, according to an embodiment of the present general inventive concept;

FIG. 6 is a flowchart illustrating an encryption method, according to an embodiment of the present general inventive concept;

FIG. 7 illustrates a graphical user interface (GUI) used for encryption, according to an embodiment of the present general inventive concept;

FIG. 8 is a flowchart illustrating a password decryption method, according to an embodiment of the present general inventive concept; and

FIG. 9 illustrates a GUI in a password decryption method, according to an embodiment of the present general inventive concept.

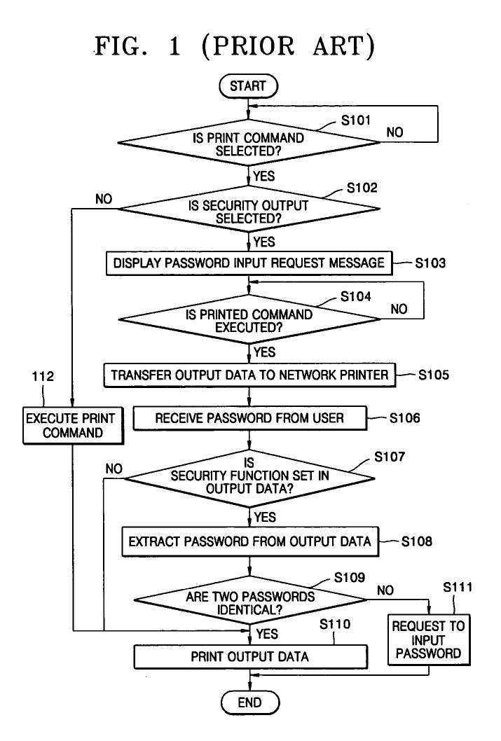

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

Various embodiments of methods and systems to provide security printing using a printer driver will now be described more fully with reference to the accompanying drawings. In assigning reference numerals to elements in the drawings, like reference numerals denote like elements even though the like elements are shown in different drawings. Also, in the description below, many details such as structural devices of detailed circuits are shown and are only provided to facilitate overall understanding. Thus, it is obvious to those skilled in the art that the present general inventive concept can be implemented without such details. Also, in the description of the present general inventive concept, related known operations or detailed explanations of configuration will be omitted.

Throughout this specification, encryption and encoding or password decryption and decoding are used as terms having the same conceptual meaning.

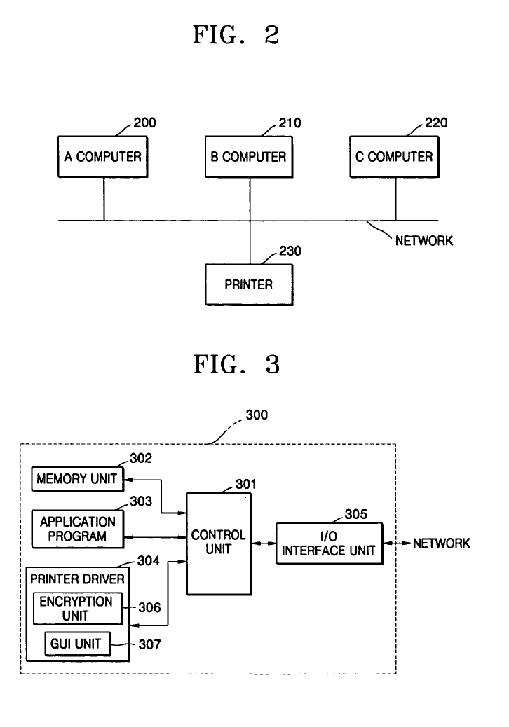

FIG. 2 is a block diagram of a system to provide security output including a general purpose printer that does not support encryption, according to an embodiment of the present general inventive concept. The system providing security output may include a plurality of general terminals 200 and 220 that are mutually connected through a network, a terminal 210 to implement a decoding operation, and a printer 230 connected to the plurality of terminals 200 and 220 through the network. The network may be a local area network (LAN) or an Internet network. The terminals 200 and 220 are connected to the network and perform the same operation, and thus only the terminal 200 will be explained in the description below.

Also, a printer connected to a predetermined network is described as an embodiment of the present general inventive concept, but the spirit and scope of the present general inventive concept is not limited to this embodiment, and can for example, be connected to a local printer that is not connected to a network.

FIG. 3 is a block diagram of the terminal 200, according to the present general inventive concept. The terminal 200 can include a control unit 301, a memory unit 302, an application program 303, a printer driver 304 including and an encryption unit 306 and a user interface (GUI) unit 307, and an input/output (I/O) interface unit 305.

Referring to FIG. 3, the memory unit 302 can store data such as various documents created in the application program 303.

The printer driver 304 can convert a document created in the application program 303 into output data that can be recognized by a printer. The printer driver 304 can also process a password input by a user or other source into binary-form data and attach the binary-form password to the front and the end of the output data. The printer driver 304 can then transmit the output data to the network printer 230 via the I/O interface unit 305.

The control unit 301 can control overall operations of respective units.

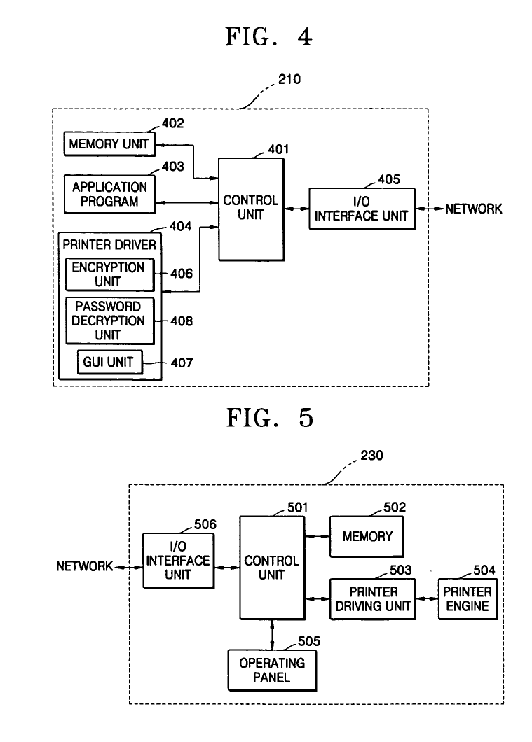

FIG. 4 is a block diagram of the terminal 210 to implement a decoding operation, according to an embodiment of the present general inventive concept. The terminal 210 can include a control unit 401, a memory unit 402, an application program 403, a printer driver 404, and an I/O interface unit 405. Unlike in FIG. 3, the printer driver 404 can further include a password decryption unit 408 in addition to an encryption unit 406 and a GUI unit 407.

Referring to FIG. 4, the memory unit 402 stores data such as various documents created in the application program 403.

The printer driver 404 can convert a document created in the application program 403 into output data that can be recognized by a printer. The printer driver 404 can also process a password input by a user into binary-form data and attach the binary-form data to the front and the end of the output data. The printer driver 404 can then transmit the output data to the network printer 230 via the I/O interface unit 405.

The control unit 401 can control overall operations of respective units.

The printer driver 304 of the general terminals 200 and 220 can include the encryption unit 306 and the GUI unit 307 and the printer driver 404 at the terminal 210 to implement a decoding operation. The printer driver 404 can further include the password decryption unit 408 in addition to the encryption unit 406 and the GUI unit 407. However, the terminals 200 and 220 may also include a password decryption unit.

FIG. 5 is a block diagram of the network printer 230, according to an embodiment of the present general inventive concept. The network printer 230 can include an I/O interface unit 506, a control unit 501, an operating panel (OPE) 505, a memory 502, a printer driving unit 503, and a printer engine unit 504.

Referring to FIG. 5, the I/O interface unit 506 can be connected to the network and can receive the output data from the terminal 210. The I/O interface unit 506 can transmit the received output data to the control unit 501.

The operating panel 505 can generate various key data and can communicate the key data to the control unit 501.

The memory 502 can store operating programs and various data of the control unit 501 of the network printer 230.

The printer driving unit 503 can drive the printer engine 504 according to a control command of the control unit 501 and can print the output data received from the terminal 210 on a printing paper or other recording medium according to control of the printer driving unit 503.

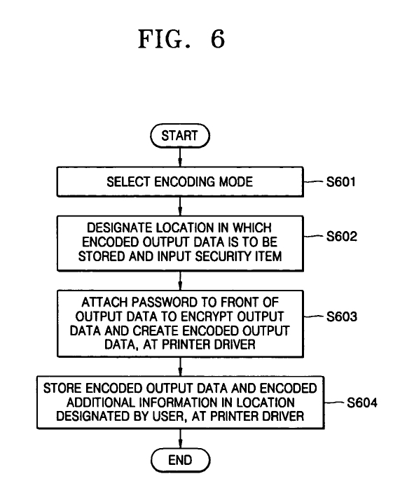

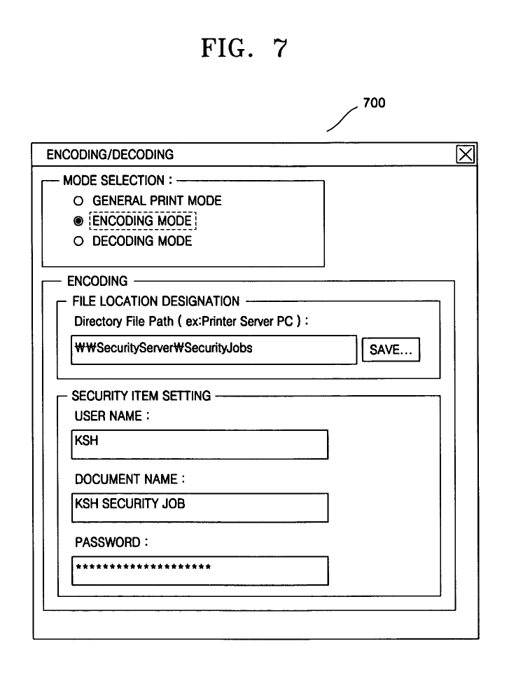

FIG. 6 is a flowchart illustrating an encryption method, according to an embodiment of the present general inventive concept. FIG. 7 illustrates a graphical user interface (GUI) used for encryption, according to an embodiment of the present invention.

According to an embodiment of the present general inventive concept, a user can select one of three modes, i.e., a general print mode that does not need security output, an encoding mode that encrypts output data, and a decoding mode that decrypts a password of the output data. Mode selection can be performed by the GUI unit 307 or 407 inside the printer driver 304 or 404, according to a print command by the user.

Once the user selects the general print mode and clicks a printing button, document data edited by the user in the application program 303 can be converted by the printer driver 304 into output data that can be recognized by the network printer 230. Thereafter, the output data can be output from the network printer 230 via the terminal 210. In the general print mode, a security operation is not used.

Hereinafter, an encryption process will be described with reference to FIGS. 6 and 7. The user can edit a document in the application program 303 of the terminal 200. To click the printing button for security printing of the document, a GUI screen as shown in FIG. 7 is displayed. The user can select the encoding mode at an upper portion of the GUI screen for encryption, in operation S601.

Simultaneously with the user's selection of the encoding mode, a GUI 700 for encryption can be displayed which can include a file location designating unit as shown in a lower portion of FIG. 7 and a security item setting unit (a user name, a document name, a password).

In operation S602, the user can designate in the file location designating unit a location in which the encoded output data is to be stored. At this time, the location can be any terminal connected to the network in FIG. 2. The user may directly write the location to a file storing location unit or designate the location through a box using a dial displayed by clicking a storage button.

The user can then write predetermined contents to the security item setting unit. In particular, the user can write the user name, the document name and the password in an edit box. At this time, the user name and the document name can be used for the user to decrypt the encrypted output data and to easily search for a file when the user desires to output data. Thus, it is an aspect of the present general inventive concept that the predetermined contents are written so they can be read and used at a later time.

The length and the type of the encryption unit are not limited, and the encryption unit may use any combinations of English letters or Arabic numerals to tighten security.

The operation of encoding additional information can include additional information such as the user name, a document name provided by a document name spooler window, time of encoding, and a file size.

The encoding additional information can use the same file name as that of the encoded output data, but can have an extension different from that of the encoded output data. For example, the output data can be named in such a way that an extension such as “.sp” (means security printing) or “.spinf” (means security printing information) is added to a document name input by the user.

Once operations of designating of the location and writing of the security item setting unit are completed and the user clicks the printing button, the encryption unit 306 of the printer driver 304 can process the password input by the user into the binary-form data. The encryption unit 306 can then attach the binary-form password to the front and the end of the output data to encrypt the output data, thus creating the encoded output data, in operation S603.

The password attached to the front and the end of the output data may not match between the printer driver 304 and the network printer 230. As a result, when the encoded output data is printed, it may be impossible to perform normal output. For example, the printer driver 304 can define the output data in session units and then use the output data, in which the beginning and the end of a session are surrounded by a specific code. In the case of PCL 6 drivers, the beginning and the end of a session are surrounded by a string <ESC> %-12345X. Since a portion surrounded by <ESC> %-12345X is defined as a session between the printer driver 304 and the network printer 230, it may not be possible to perform normal operation. <ESC> %-12345X is of a kind of universal end of language commands (UEL).

The encoded output data and the encoded additional information are stored in a predetermined location designated by the user, in operation S604. The encoded additional information can be read out when the decoding additional information is displayed as shown in FIG. 9.

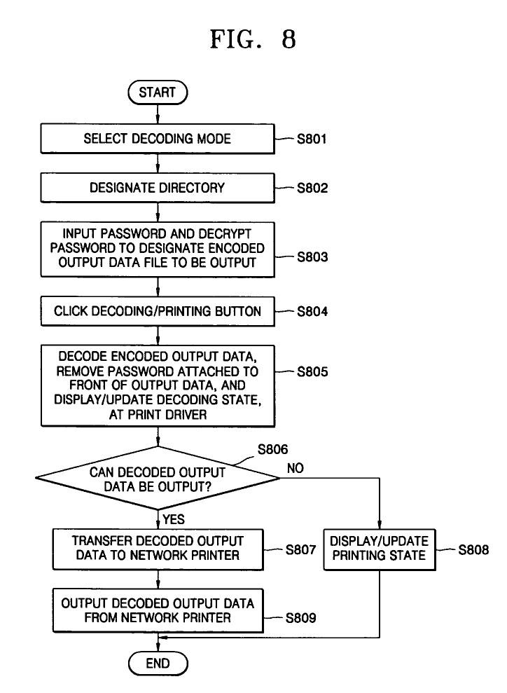

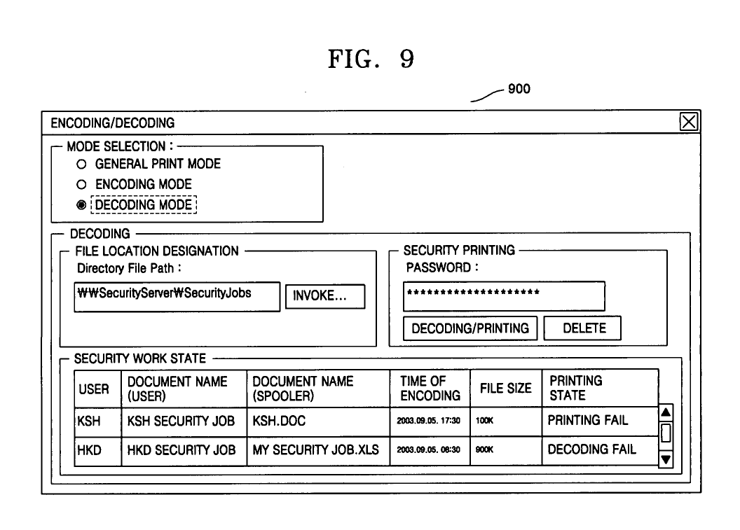

FIG. 8 is a flowchart illustrating a password decryption method, according to an embodiment of the present general inventive concept. FIG. 9 illustrates a GUI 900 in a password decryption method, according to an embodiment of the present general inventive concept.

Once the user clicks the printing button in an application program, the GUI 900 as shown in FIG. 9 can be displayed. If the user clicks the decoding mode in operation S801, the GUI 900 as shown in FIG. 9 can also be displayed.

The GUI 900 can include a file location designating unit, a password input unit, and a security work state unit that includes a user name, a document name, a document name provided by a spooler, time of encoding, a printed file size, and a printing state unit.

The printing state unit can display and update a decoding state and a printing state of the encoded output data, according to user's click of a decoding/printing button.

As in the GUI 700 used for the encoding, the user may designate a directory that stores a file in the decoding operation by directly writing the directory to the file location designating unit or by using a dialog box displayed by clicking an invoke button.

In operation S802, the user can designate a directory that stores a file to be password decrypted and output from among terminals connected through the network. A security output file of the directory to be output securely, can then be enumerated in the security work state unit.

The printer driver 404 can read the user name, the document name, the document name of the spooler window, time of encoding, and the file size from the encoding additional information that are stored in encryption in the security work state unit and can display them. In other words, the printer driver 304 can store the encoded additional information in the encoding operation, and the printer driver 404 can read and display the encoded additional information in the decoding operation.

In operation S803, the user can input the password which is then decrypted in the security work state unit to designate the encoded output data file to be output.

In operation S804, if the user decodes the encoded output data file and desires to output the decoded output data file, the user clicks the decoding/printing button.

According to user's click of the decoding/printing button, the password decryption unit 408 of the printer driver 404 can sequentially compare the password input by the user and the encoded output data from the beginning of the encoded output data.

After portions of the encoded output data that are identical to the password input by the user are deleted, it can be checked if there is a string match between the printer driver 404 and the network printer 230. The string can be<ESC> %-12345×, as described in relation to encoding.

In operation S805, if there is a string match, a “decoding success” message is displayed in a printing state box of the security work state unit. In operation S805, if there is no matched string, a “decoding fail” message is displayed. The messages indicate whether the password input by the user is identical to the password included in the document. Even though the password input by the user is different from the password included in the document, if the user inputs a correct password later, the decoding state can be updated and displayed.

In operation S806, the printer driver 404 can check if the password is deleted normally and the decoded output data can be output. If the password is deleted normally, the printer driver 404 can proceed to operation S807, which transfers the decoded output data to a predetermined available port.

Operation 809 can output the decoded output data from the network printer. Once printing is terminated normally in the network, a printing state message (e.g., a “printing complete” message or a “printing failed” message) can be output from the control unit 501 of the network printer 230 and, for example, a “printing complete” message can be displayed on a printing state display unit.

In operation S808, if the password is not deleted normally and the decoded output data cannot be output, the “printing failed” message can be displayed or updated and printing is terminated.

In an embodiment of the present general inventive concept, a delete button can be further included in addition to the decoding/printing button. If the user clicks the delete button, a corresponding file can be deleted from the security work state unit. The encoded additional information file can also be deleted along with the encoded output data file.

As described above, by performing password decryption at a printer driver level, it is possible to perform security printing using a low-cost, general purpose printer that does not support encryption.

Also, it is possible to more flexibly implement a security operation by implementing the security operation using software instead of hardware.

Also, it is possible to tighten security of output data by disabling output of output data until a password is decrypted using a password input by a user.

All of the methods described herein can be programmed to be performed on a digital computer. Such a program can be stored on any type of computer readable storage medium (i.e. CD-ROM, hard drive, etc.)

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A method of providing security printing on a network printer that includes at least one terminal having a printer driver and a network printer connected to the terminal via a network, the method comprising the operations of:
encoding output data at a first terminal and storing the encoded output data in a predetermined location designated by a user; and
decoding the encoded output data that is stored in the predetermined location at a second terminal, into decoded output data and transferring the decoded output data to the network printer and printing the decoded output data.

2. The method of claim 1, wherein the encoding operation comprises:
receiving a password from an external source;
encoding the password and the output data to create the encoded output data; and
storing the encoded output data in the predetermined location.

3. The method of claim 2, wherein the encoding operation further comprises storing an encoding additional information file in the predetermined location, the encoding additional information file including at least a user name, a document name, a file size, and time of encoding.

4. The method of claim 3, wherein the encoding additional information file uses the same file name as that of the encoded output data, but has an extension different from that of the encoded output data.

5. The method of claim 1, wherein the predetermined location is a terminal connected to the network.

6. The method of claim 2, wherein the predetermined location is a terminal connected to the network.

7. The method of claim 3, wherein the predetermined location is a terminal connected to the network.

8. The method of claim 1, wherein the decoding operation comprises:
receiving a password and a decoding/print command from the user at the first terminal;
extracting a password included in the encoded output data at the second terminal according to the decoding/print command;
comparing the extracted password with the password input by the user; and
deleting the extracted password, decoding the output data, and transferring the decoded output data to the network printer, if the two passwords are identical.

9. The method of claim 8, wherein the decoding operation further comprises displaying a decoding additional information file, and the decoding additional information file reads and displays the encoding additional information file.

10. The method of claim 8, wherein the decoding operation further comprises displaying a result of the decoding and a printing state.

11. The method of claim 9, wherein the decoding operation further comprises displaying a result of the decoding and a printing state.

12. A computer-implemented method to provide security printing, comprising:
inputting an encoding password, and a data file and a location identifier identifying a location;
attaching the encoding password to the data file to form an intermediate file;
encrypting the intermediate file to form an encoded file; and
storing the encoded file on a storage device located at the location.

13. The method as recited in claim 12, further comprising:
inputting a decoding password and an identifier for the encoded file;
decoding the encoded file into output data and a decoded password; and
determining if the decoding password matches the decoded password, and outputting the output data on an output device located at the location if it is determined that there is a match.

14. A computer readable storage medium containing a method that provides security printing on a network printer that includes at least one terminal having a printer driver and a network printer connected to the terminal via a network, the method including the operations of:
encoding output data at a first terminal and storing the encoded output data in a predetermined location designated by a user;
decoding the encoded output data that is stored in the predetermined location at a second terminal;
transferring the decoded output data to the network printer; and
printing the decoded output data.

15. A computer readable storage medium to provide security printing by controlling a computer to perform the operations of:
inputting an encode password and a data file and a location identifier identifying a location, at a first terminal;
attaching the encode password to the data file to form an intermediate file;
encrypting the intermediate file to form an encoded file; and
storing the encoded file on a storage device located at the location.

16. A system providing security printing which includes at least two terminals having printer drivers and a network printer connected to the terminals via a network, wherein the terminals comprise:
a first terminal which receives a password from a user, encodes the password and output data, and stores the encoded output data in a predetermined location; and
a second terminal which decodes the encoded output data that is stored in the predetermined location and outputs the decoded output data to the network printer.

17. The system of claim 16, wherein the first terminal includes the printer driver, wherein the printer driver comprises:
an encoding unit to receive the password from the user and to store in the predetermined location the encoded output data obtained by encoding the password and output data; and
a user interface unit to receive the password or a control command from the user or to display a security work state and to act as an interface between the user and the first terminal.

18. The system of claim 16, wherein the second terminal comprises the printer driver, wherein the printer driver decodes the encoded output data which is stored in the predetermined location and outputs the decoded output data to the network printer.

19. The system of claim 16, wherein the predetermined location is a terminal connected to the network.

20. The system of claim 17, wherein the predetermined location is a terminal connected to the network.

21. An apparatus to implement security printing, the apparatus comprising:
a first input unit to input an encode password and a data file and a location identifier identifying a location;
an attaching unit to attach the encode password to the data file to form an intermediate file;
an encryption unit to encrypt the intermediate file to form an encoded file; and
a storing unit to store the encoded file on a storage device located the location.

22. The apparatus as recited in claim 21, further comprising:
a second input unit to input a decode password and an identifier for the encoded file;
a decoding unit to decode the encoded file into output data and a decoded password; and
a determining unit to determine if the decode password matches the decoded password, and if there is a match then outputting the output data on an output device located at the location.

23. The apparatus as recited in claim 22, wherein a printer driver used to output the output data comprises the decoding unit.
